(19) United States
(12) Patent Application Publication
(10) Pub. No.: US 2025/0050767 A1
(43) Pub. Date: Feb. 13, 2025

(54) CHARGING DEVICE AND SYSTEM WITH WATER TANK

(71) Applicant: AUDI AG, Ingolstadt (DE)

(72) Inventor: Ralph HOLLMIG, Ingolstadt (DE)

(21) Appl. No.: 18/797,368

(22) Filed: Aug. 7, 2024

(30) Foreign Application Priority Data
Aug. 10, 2023 (DE) 102023121349.0

(51) Int. Cl. B60L 53/302; B60L 53/16; E04H 6/02

(52) U.S. Cl. CPC B60L 53/302; B60L 53/16; E04H 6/025

(57) ABSTRACT

A charging device is provided for at least one electrically drivable vehicle with at least one traction battery, having at least one charging plug which is designed to supply the traction battery of the vehicle with electrical energy, and having at least one electrical component, wherein the charging device has at least one water tank filled with water, wherein the charging device is designed to transfer waste heat generated due to power loss from at least one electrical component directly or indirectly to the water fed into the water tank. A charging system is also provided.

### BACKGROUND

### Technical Field

The present disclosure relates to a charging device for at least one electrically drivable vehicle with at least one traction battery, having at least one charging plug which is designed to supply the traction battery of the vehicle with electrical energy. The present disclosure also relates to a charging system.

### Description of the Related Art

In addition to charging poles or so-called wall boxes, charging stations or charging hubs are also known for charging electrically powered vehicles. Such infrastructures for the electrical charging of traction batteries are primarily geared towards charging and usually do not have any other functionalities.

Depending on the configuration of charging stations, they can be covered by roof structures to protect the charging poles or charging boxes and the parked vehicles from direct weather conditions.

The document CN113442762 A describes a charging pole with a pole roof for collecting rainwater and electrical plugs for charging vehicle-side traction batteries. The rainwater is filtered and can be drawn via a tap when required.

From the document CN218400249 U, a charging pole for charging vehicle-side traction batteries with a cooling system based on water evaporation is known. Here, rainwater can be collected using a trough-shaped roof and evaporated in a heat exchanger. The water is evaporated in a closed circuit and condensed again by fans in order to direct the condensed water back into a water tank. Such a system requires a large number of components and complex control of the water supply in order to enable efficient cooling of the power loss generated.

### BRIEF SUMMARY

The present disclosure provides a charging device and a charging system which enable efficient and technically simple cooling of components.

The charging device described herein is used to charge traction batteries of electrically drivable vehicles, such as, for example, BEV (Battery Electric Vehicle) or HEV (Hybrid Electric Vehicle). Hereby, the charging device can be configured as a stationary or as a mobile unit.

A mobile charging device can, for example, be set up at different locations and does not necessarily need an electrical connection for operation. For this purpose, an electrochemical storage device within the charging device can be charged in advance so that traction batteries in vehicles can then be charged.

A stationary charging device can be permanently installed and coupled to an infrastructure-side electrical connection to ensure charging operation.

The charging device described herein has at least one charging plug which is designed to supply the traction battery of the vehicle with electrical energy. For this purpose, the charging plug can interact with a vehicle-side charging socket in order to implement an energy transfer. The charging device also has at least one electrical component and at least one water tank which is or can be filled with water.

The charging device described herein is designed to transfer waste heat generated during a charging process due to power loss from at least one electrical component directly or indirectly to the water fed into the water tank.

According to a further aspect of the of the present disclosure, a charging system is provided. The charging system has at least one charging device described herein and at least one parking area for at least one vehicle arranged adjacent to the charging device. The vehicle can thus be parked next to the charging system during a charging process.

By releasing the waste heat to the water in the water tank, customers can draw tempered water all year round, for example to fill up a vehicle-side windshield washer fluid tank or a water tank for cleaning vehicle-side sensors.

Furthermore, the conventional functionality of a charging device can be extended by secondary effects, such as, for example, waste heat storage in water and water collection, in order to increase the efficiency of the charging system. For example, rainwater can be collected from a roof structure or the parking areas, filtered through at least one filter and then fed into the water tank.

In one embodiment, at least one wall of the water tank is covered on the outside by at least one wall of the charging device. Alternatively, or additionally, the at least one water tank forms at least one outside wall of the charging device. This measure allows the at least one water tank to be integrated into the charging device in a particularly advantageous manner.

According to a further embodiment, the at least one water tank may be thermally coupled to the at least one electrical component directly by direct contact or by a cooling circuit, such as by pipes and/or heat exchangers integrated into the water tank. As a result, components with a particularly high-power loss can be attached directly to the water tank in order to use it as a heat sink. Alternatively, one or more components can be thermally coupled to the water tank via one or more cooling circuits. One or more heat exchangers, for example in the form of pipes or finned tubes, can be arranged in the water tank or on the water tank in order to enable particularly optimal heat transfer.

According to a further embodiment, the at least one water tank may be indirectly thermally coupled to the at least one electrical component by radiant heat and/or convection within the charging device. As a result, the electrical components of the charging device can be encapsulated by the outer walls and heat an internal volume of the charging device through their power loss. The water tank and the water in the water tank can then be heated via the heated internal volume. Due to the high specific heat capacity of the water, a technically simple heat source can be provided by the at least one water tank.

Depending on the configuration, this indirect heat transfer to the water tank can be optimized if the internal volume is not filled with air, but with a gas or gas mixture, such as, for example, helium, which has improved thermal conductivity.

According to a further embodiment, the charging device may have at least one removal point for manual and/or automated removal of the water heated in the water tank by the waste heat. This measure allows the water held in the water tank and pre-heated by the waste heat to be made available to users of the charging device.

Transferring the waste heat to the water prevents the water from freezing at low outside temperatures and can be used not only to fill vehicle-side water tanks but also, for example, to gently de-ice windshield washer nozzles, glass panes and the like.

For this purpose, a water hose can be connected to the removal point. Alternatively, the removal point can be provided with a permanently connected water hose.

According to a further embodiment, the at least one electrical component may be configured as an electrochemical storage device integrated into the charging device, as charging electronics, as a converter, as a transformer and/or as an electrical interface of the charging plug. The charging device with an electrochemical storage device can advantageously be configured as a mobile charging device which, after an initial charging of the electrochemical storage device, can deliver its energy to traction batteries of vehicles at a location without electrical infrastructure. All electrical consumers and components within the charging device can be used to heat the water in the water tank. In particular, the water serves as a technically simple heat sink. The resulting pre-heating of the water enables a convenient service option, such as at low outside temperatures, for customers of the charging device.

According to one embodiment of the charging system, the charging system may have at least one roof structure which covers at least in certain areas of the at least one charging device and/or the at least one parking area. In some embodiments, the roof structure may be designed to collect rainwater and direct it into at least one water tank of the at least one charging device. For this purpose, the roof structure can have at least one incline or slope which opens into a gutter and/or a drainage channel. The rainwater can then be directed directly into the at least one water tank via a hose system or a pipe system. Depending on the configuration, one or more filters can be arranged between the water tank and the roof structure in order to treat the rainwater.

According to a further embodiment of the charging system, the roof structure may rest on the at least one charging device and/or is supported by support elements at least in certain areas. As a result, the at least one charging device can be used at least in certain areas as a structural element for holding or supporting the roof structure. The number of support pillars or support elements required for positioning the roof structure can at least be minimized.

### BRIEF DESCRIPTION OF THE SEVERAL VIEWS OF THE DRAWINGS

Aspects of the present disclosure are illustrated schematically in the drawings using embodiments and is further described with reference to the drawings.

FIG. 1 shows a charging system according to a first embodiment of the present disclosure.

FIG. 2 shows a charging system according to a second embodiment of the present disclosure.

### DETAILED DESCRIPTION

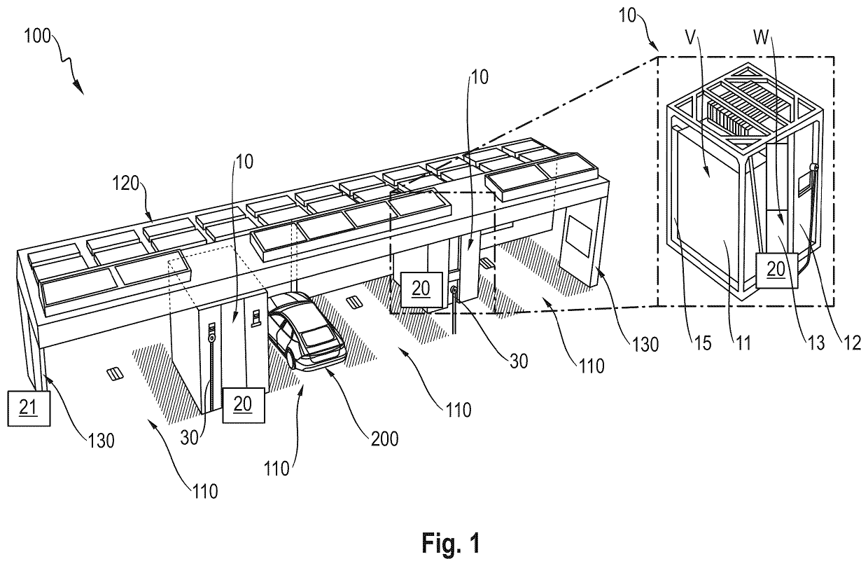

FIG. 1 shows a charging system 100 according to a first embodiment of the present disclosure. The charging system 100 has, for example, two charging devices 10. Parking areas 110 for vehicles 200 are provided adjacent to charging devices 10. A parking area 110 is positioned on both sides of each charging device 10. A vehicle 200 is parked on a parking area 110 to illustrate a charging process.

In the illustrated embodiment, the charging system 100 has a roof structure 120 which completely covers charging devices 10 and parking areas 110.

The roof structure 120 rests on the charging devices 10 at least in certain areas and on support elements 130 or support pillars, at least in certain areas.

The charging devices 10 are used to charge traction batteries (not shown) of electrically drivable vehicles 200, such as, for example, BEV (Battery Electric Vehicle) or HEV (Hybrid Electric Vehicle). For example, charging devices 10 are configured as a stationary unit. To compensate for load peaks, charging devices 10 have integrated electrochemical storage devices 11. The charging device 10 can use the energy stored in the electrochemical storage device 11 and/or the energy of a fixed electrical connection (not shown) to charge traction batteries.

The charging devices 10 have charging plugs 30 on both sides, which are designed to be coupled to corresponding charging sockets of vehicles 200 in order to supply the traction batteries of vehicles 200 with electrical energy.

In addition to the electrochemical storage device 11, the charging devices 10 have at least one further electrical component 12. This can be configured in the form of converters, transformers, charge controllers and the like. The electrochemical storage device 11 can also be considered an electrical component.

In operation of the charging device 10, such as in the charging operation, the electrical components 11, 12 generate waste heat due to power losses and internal electrical resistances. This waste heat is used to heat at least one water tank 13 and/or a quantity of water W stored in the water tank 13.

The waste heat generated due to power loss from at least one electrical component 11, 12 can be transferred directly or indirectly to the water W fed into the water tank 13. FIG. 1 schematically shows indirect heat transfer through convection or radiant heat. For this purpose, all electrical components 11, 12 and the water tank 13 are enclosed in a common internal volume V of charging device 10 by outer walls 15 of charging device 10.

In the illustrated embodiment, the water tank 13 is arranged between the electrochemical storage device 11 and a charging controller 12. These electrical components 11, 12 can also form direct physical contact with the water tank 13 and enable direct heat transfer by thermal conduction.

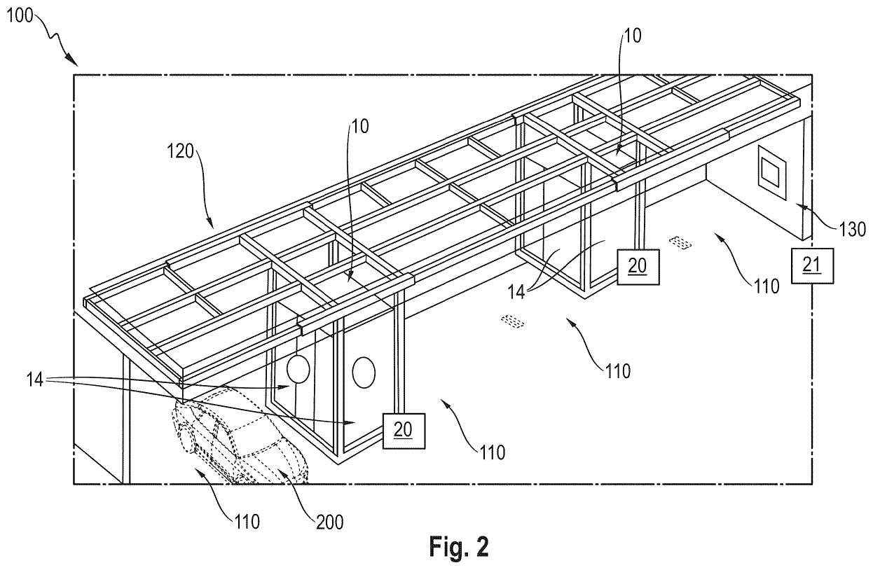

FIG. 2 shows a charging system 100 according to a second embodiment of the present disclosure. In contrast to the charging system 100 shown in FIG. 1, the charging devices 10 here have several water tanks 14, which are configured as outer walls of each respective charging device 10. Water tanks 14 are positioned between corner pillars in an inner volume V of the charging device 10.

In the embodiments shown, the water W from the water tanks 13, 14 can be removed via decentralized removal points 20 or removal points 20 arranged on the charging devices 10 or via a central removal point 21, for example to fill vehicle-side water containers.

The roof structures 120 can advantageously be used to collect rainwater. The collected rainwater can then be fed into the water tanks 13, 14 of the charging devices 10 via pipes or hoses (not shown). Depending on the configuration, fill level sensors (not shown) can be used to prevent the water tanks 13, 14 from overflowing.

In an alternative and technically simple solution, if the water tanks 13, 14 overflow, the excess rainwater can be drained off via alternative drain pipes. Depending on the location of the charging system 100, the rainwater can be treated by at least one filter, sieve and/or separator before being fed into the water tanks 13, 14.

German patent application no. 10 2023 121349.0, filed Aug. 10, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging device for at least one electrically drivable vehicle with at least one traction battery, the charging device comprising:
at least one charging plug configured to supply the at least one traction battery of the vehicle with electrical energy;
at least one electrical component; and
at least one water tank filled with water, and
wherein the charging device is configured to transfer waste heat generated due to power loss from the at least one electrical component directly or indirectly to the water fed into the at least one water tank.

2. The charging device according to claim 1, wherein at least one wall of the water tank is covered on the outside by at least one wall of the charging device and/or wherein the at least one water tank forms at least one outside wall of the charging device.

3. The charging device according to claim 1, wherein the at least one water tank is thermally coupled to the at least one electrical component directly by direct contact or by a cooling circuit.

4. The charging device according to claim 3, wherein the cooling circuit comprises pipes and/or heat exchangers integrated into the water tank.

5. The charging device according to claim 1, wherein the at least one water tank is thermally coupled to the at least one electrical component indirectly by radiant heat and/or convection within the charging device.

6. The charging device according to claim 1, wherein the charging device has at least one removal point for manual and/or automated removal of the water heated in the water tank by the waste heat.

7. The charging device according to claim 1, wherein the at least one electrical component is configured as an electrochemical storage device integrated into the charging device, as charging electronics, as a converter, as a transformer and/or as an electrical interface of the charging plug.

8. A charging system, comprising:
at least one charging device according to claim 1; and
at least one parking area for at least one vehicle arranged adjacent to the at least one charging device.

9. The charging system according to claim 8, wherein the charging system has at least one roof structure which covers at least certain areas of the at least one charging device and/or the at least one parking area, wherein the at least one roof structure is configured to collect rainwater and direct the rainwater into at least one water tank of the at least one charging device.

10. The charging system according to claim 9, wherein the at least one roof structure rests on the at least one charging device and/or is supported at least in certain areas by support elements.
